(19) United States
(12) Patent Application Publication
(10) Pub. No.: US 2017/0341437 A1
(43) Pub. Date: Nov. 30, 2017

(54) WEB WINDING WITH FRICTION-BASED TENSIONING

(71) Applicant: Océ Holding B.V., Venlo (NL)

(72) Inventors: Juan C. PÉREZ MUÑOZ, Venlo (NL); Lodewijk T. HOLTMAN, Venlo (NL)

(73) Assignee: Océ Holding B.V., Venlo (NL)

(21) Appl. No.: 15/603,009

(22) Filed: May 23, 2017

(30) Foreign Application Priority Data
May 30, 2016 (EP) 16171929.9

(51) Int. Cl. B41J 15/16; B65H 23/08; B41J 2/33; B41J 15/02; B41J 15/04; B41J 2/325

(52) U.S. Cl. CPC B41J 15/165; B41J 2/33; B41J 15/02; B65H 23/085; B41J 2/325; B41J 15/16; B65H 23/08; B41J 15/04

(57) ABSTRACT

A printing system includes a transport path for transporting a web medium. The transport path includes a slack region wherein the web medium is slack or substantially tension-free. A take-up roller is positioned at a downstream end of the transport path for receiving and winding the web medium. A tensioning device is positioned along the transport path between the slack region and the take-up roller. The tensioning device includes a first surface arranged for exerting a friction force on the web medium moving over the first surface in a direction opposite to a transport direction of the transport path, such that the web medium is tensioned between the tensioning device and the take-up roller. Since the friction force tensions the web being wound onto the take-up roller, the wound media rolls are tightly wound when applying “loose winding.”

### BACKGROUND OF THE INVENTION

### 1. Field of the invention

The invention relates to a printing system for web media, a tensioning device, as well as to a method for winding web media unto a take-up roller of a printing system.

### 2. Description of Background Art

In the graphic arts reprographic devices, media such as posters and banners are printed on web media. The web media are provided on rolls and after printing wound up onto an empty roll core provided on a take-up roller. This is referred to as roll-to-roll printing. In order to prevent the take-up roller from pulling on a section of the medium below the print heads, a buffer zone is provided between the print heads and the take-up roller. The buffer zone allows the web to locally hang slack in the form of a so-called blouse, such that the pulling forces from the take-up roller are decoupled from the section of the web medium upstream of the tension-free zone of the blouse. This results in high quality printing since the medium's position on the print surface is not disturbed while printing. The take-up roller winds upon itself the substantially tension-free part of the web from the buffer region. A drawback is that the web medium is very loosely wound onto the roll core, resulting in a relatively large media roll diameter, which requires more storage space. Further, the loosely wound media roll may slide over itself or the roll core, resulting in damage to the printing image. Another drawback is that the media roll is difficult to handle as the rolled up web medium will start to shift over the roll core when the roll core is not held horizontally.

### SUMMARY OF THE INVENTION

It is an object of the invention to provide a simple and easy to operate device for tensioning webs of print media being fed to a winder.

In accordance with the present invention, a printing system according to claim 1 and a method according to claim 11 are provided.

The present invention provides a printing system for web media, comprising:
a transport path for transporting a web medium through the printing system, the transport path comprising a slack region wherein the web medium is slack;
a take-up roller positioned at a downstream end of the transport path for receiving and winding the web medium;
a tensioning device positioned along the transport path between the slack region and the take-up roller, the tensioning device comprising:
   a stationary first surface;
   an urging device for urging the web medium against the first surface, such that the first surface exerts a friction force on the web medium moving over the first surface in a direction opposite to a transport direction of the transport path, thereby tensioning the web medium between the tensioning device and the take-up roller.

It is the insight of the inventors that a tensioning device may be simplified by allowing the friction force to be generated between the web medium and a stationary support surface if the web is urged against this support surface. The friction providing support surface can then be easily produced from e.g. a simple plate. The small friction force on the web medium between the slack region and the take-up roller then provides a constant tensioning force opposite to the pulling force of the take-up roller, which tensioning force results in the web being wound tautly around the take-up roller. A further advantage is that the transport path, and thereby the feeding of the print media, may be kept simple as the static support surface provides a suitable guide for feeding media. Additionally, the operation of the device is improved as the tensioning device according to the present invention allows for easy feeding of new web media. The stationary first surface, with the urging device in an inactive mode, still forms a suitable transport path for feeding the medium to the take-up roller. The tensioning device according to the present invention due to its simplified construction is easily switched to a state or mode wherein the urging device does not impede the web transport.

The web medium is provided from a take-out roller via the transport path onto a print surface below the print heads. There, an image is printed on the medium. Downstream of the print head the web medium passes into the slack region of the transport path. In the slack region the web medium is allowed to be or hang slack, such that the tension in the medium in the slack region is substantially absent or determined predominantly by gravity acting on the medium in the slack region. Thus, upon entering the slack region the tension in the medium is significantly reduced with respect to the tension in the medium upstream of the print heads.

The take-up roller pulls the substantially slack medium from the slack region over the first surface of the tensioning device. The urging device urges the web medium against the first surface, thereby generating a friction force between the web medium and the first surface, which friction force acts opposite to the transport direction of the medium as well as opposite to the pulling force resulting from the take-up roller. Thereby, the web medium is pulled taut between the tensioning device and the take-up roller. The friction force acts on the web medium while it moves over the first surface, providing a continuous force opposite to the pulling force of the take-up roller. These opposing forces result in the web medium between the tensioning device and the take-up roller becoming tensioned with respect to the web medium in the slack region. The resulting tension force basically pulls the web taut as it is being wound onto the take-up roller, resulting is a compactly wound media roll. Therein the chance of lateral slipping or shifting of the web media is reduced, since substantially no air is trapped between the layers of the media roll and/or the roll core. Thereby the object of the present invention has been achieved.

More specific optional features of the invention are indicated in the dependent claims.

In an embodiment, the urging device is configured, such that an urging force exerted by the urging device on the web medium is substantially perpendicular to the web medium on the first surface. The urging force is substantially perpendicular to the transport direction, such that the urging force itself does directly not impede transport of the web medium. Any component of the urging force parallel to the transport direction is thus very small or substantially zero. This is particularly advantageous if the urging device engages the printed side of the web medium, while the first surface engages an unprinted side. The risk of damaging the structure of the printed image is thus reduced.

In another embodiment, the urging device is configured, such that:
the friction force acts on a first side of the web medium facing the first surface; and
an urging force exerted by the urging device on a second side of the web medium does not substantially impede movement of the web medium in the transport direction. The second side is the printed or top side of the web medium, while the first side is the bottom side facing the first surface. The urging device then presses onto the second side of the web medium, in a manner without laterally or longitudinally (with respect to the transport direction) disturbing the medium. The longitudinal friction force is then generated by contact of the bottom side with the first surface, but does not act directly on the printed image.

In a further embodiment, the printing system according to any of the previous claims, further comprising a stationary page-wide support element for supporting a bottom side of the web medium, said stationary support element comprising the stationary first surface. The stationary page-wide support element defines transport path and provides support for feeding the medium to the take-up roller. Preferably, the support element comprises a support plate forming the support surface. The support surface is preferably smooth and/or continuous to ensure unhindered movement of the web medium there over.

In a preferred embodiment, the slack region defines a substantially tension-less or tension-free region of the web medium. Slack is herein defined as the medium or sections thereof comprising little to none tension, when not in motion. Thereto, the web may be positioned loosely on the transport path. Any constant tension in the slack medium may due to gravity acting on the medium. Any forces required for transporting the web medium are preferably oriented along the transport direction, wherein forces working against the transport direction are substantially absent or minimal. Preferably, in the slack region, the web medium passes through a U-shaped or S-shaped fold, such that pulling forces acting on a section of the medium downstream of the slack region are decoupled from a section of the medium upstream of the slack region. The web medium in the slack region curves downwards under the effect of gravity acting on it. In a preferred embodiment, the slack region is defined by an upstream support element and a downstream support element for supporting a bottom side of the web medium, such that the web medium hangs unsupported or free between the upstream support element and a downstream support element. A pivotable support plate may be provided between the support elements to allow to a leading edge of the web medium to pass there over onto the take-up roller before pivoting the support plate to an open position to allow the formation of a blouse in the slack region. The slack region prevents pulling forces from the take-up roller from reaching the medium below the print heads and disrupting the printed image. This results in high quality printing. The decoupling of forces acting on the web upstream and downstream of the slack region may be achieved by an interruption or discontinuity in the web medium, such that the medium is positioned loosely or tension-free in slack region. Such a discontinuity may be formed by a blouse or a cut. In the latter case, the slack region may be positioned between a cutter and the tensioning device. By cutting the web medium, a free and thereby tension-less end of the medium may extend upstream from the tensioning device.

A further advantage of the friction-based tensioning device according to the present invention is that the friction force aids in holding the web medium in its desired position on the first surface. In the prior art, the web medium rest loosely on a support surface of the downstream support element of the slack region. In consequence any lateral force on the web medium causes the web medium to move sideways in the width direction of the web medium. Such lateral forces generally originate from the take-up roller when the web medium is not properly aligned on the take-up roller. The tensioning device provides an opposing force to said lateral forces, thereby preserving the desired position of the web medium. Similarly the tensioning device holds the web medium in its position in the transport direction. The speed with which the web medium moves over the first surface and thereby out of the slack region or buffer region, should not exceed the speed with which the web medium enters the slack region to prevent the web medium in the slack region from being pulled taut. In practice this occurs when a relatively heavy medium starts sagging between the downstream support element of the slack region and the take-up roller. A gravity force acting on the web medium between the slack region and the take-up roller pulls the web medium from the slack region over the downstream support element at a greater speed than the average transport speed of the web medium. The blouse is thereby effectively transferred from the slack region to in between the slack region and the take-up roller. The web medium may then come into contact with the floor and become dirty. The media roll will further become very loosely wound. This is prevented by the tensioning device according to the present invention wherein the friction force prevents the web medium from sliding over the first surface at a too great speed. The tensioning device ensures the web always taut, ensuring a constant transport speed over the entire web medium along the transport path. This further allows an operator to accurately set the size of the blouse in the slack region, which size will remain constant during further printing, since the tensioning device ensures the transport speed of web media leaving the slack region is equal to that of web media entering the slack region.

The tensioning device further aids in continuous printing while cutting the medium. Winding may continue, while the blouse is reduced or “eaten up” prior to cutting to prevent the medium from falling onto the ground after cutting. The tensioning device additionally allows a cut web medium to be wound under tension.

In an embodiment, the first surface of the tensioning device is arranged for contacting a first side of the web medium, the tensioning device further comprises a second surface for contacting a second side of the web medium, and the second surface is positioned with respect to the first surface to urge the web medium against the first surface, such that the first surface exerts the friction force on the web medium. The second surface provides an urging force directing the web medium to and against the first surface. The urging force determines the magnitude of the friction force, allowing for a controlled or controllable setting of the friction force. Thereby, the friction force may be adjusted with respect to different characteristics of the applied web media. In one example, the first and second surface may be opposing surfaces (i.e. facing one another), such that one surface may press the web medium onto the other surface. In another example, the first and second surfaces define an S-shaped curve in the transport path to provide the friction force.

In a further embodiment, the urging device is arranged for providing a pressure on the web medium to urge the web medium against the first surface. The urging device may be a suction source providing an under-pressure to the first side of the web medium or a pressing device pressing onto the second side of the web medium to press the first side of the web medium against the first surface.

In a further embodiment, the urging device is arranged for urging the second surface towards the first surface. The urging element may be an active or dynamic urging element, such as a controllable actuator or spring. The urging element allows for an adjustment and a setting of the friction force. The friction force is preferably selected to lie below a tearing threshold, such that tearing of the web medium between the tensioning device and the take-up roller is prevented. The urging element preferably sets the friction force below the pulling force of the take-up roller for each media type used. A controllable friction force allows for greater media variability.

In an even further embodiment, the tensioning device further comprises a roller, and at least one of the first surface and the second surface is provided on a circumferential surface of the roller. Preferably, the circumference of the rollers forms the second surface. The roller is connected to a fixed frame of the printing system by means of the urging device or element, for example a spring. The urging element pushes the roller onto the web medium on the first surface, which results in the first surface exerting a friction force on the web medium. Preferably, the urging force is perpendicular to the transport direction of the medium, as well as to the plane of the web medium to prevent the web medium shifting over the first surface. Since, the roller is rotatable around its rotation axis, it exerts little to no force on the web medium parallel to the transport direction. In consequence, the friction force is directly determined by or proportional to a magnitude of the urging force, allowing for an accurate control of the friction force.

In another embodiment, the tensioning device further comprises a plurality of laterally spaced apart rollers and a support plate forming the first surface, wherein the urging device comprises a plurality of urging elements for urging each roller towards the first surface on the support plate. Two or more rollers or wheels or rotatably provided over the support plate. The wheels are positioned at different width positions over the support plate, preferably along a common lateral line. The width positions may be selected in accordance with the size of the web medium. An urging element, such as a spring, is provided to urge each roller towards the support plate. Thereby, the present invention provides a very simple and compact tensioning device.

In a further embodiment, the roller is rotatable around a rotation axis substantially parallel to a plane of the web medium on the transport path, and the roller is further pivotable around a pivoting axis perpendicular to the plane of the web medium on the transport path, such that the roller may pivot over the web medium on the transport path. In this manner, the roller may pivot freely over the web medium under the influence of the friction force. This prevents the web medium from shifting or wrinkling when the roller and the web medium are not properly aligned. Any deviation between the orientation of the web and the orientation of the roller is automatically corrected by letting the roller pivot freely over the web medium. Further, a pair of positioning flanges may be provided on the first surface to determine the position of the medium on the transport path. The positions of said flanges are preferably adjustable in the width direction of the transport path to conform to different media widths. The pivotable tensioning device is particularly advantageous when using such adjustable flanges to correct or adjust the position of the medium, since the tensioning device will then not exert any forces on the medium in the width direction. Thereby, the lateral position of the medium is accurately controllable.

In a preferred embodiment, the slack region is formed by a buffer zone arranged for forming a blouse in the web medium on the transport path. The blouse hangs between the upstream and downstream support elements. The downstream support element may in another embodiment comprise the first surface. The blouse decouples the forces of the take-up roller from the section of the medium below the printing assembly, ensuring an accurate positioning and high quality printing.

In another embodiment, the tensioning device further comprises a clamp with an actuator for opening the clamp such that the web medium is allowed to be transported to the take-up roller and for closing the clamp such that the web medium is locally held in place with respect to the transport path. The tensioning device is arranged for exerting the friction force on the web medium when the clamp is open. When starting a print job, the web medium is fed into the printing system from the take-out roller. When a predefined length of the medium downstream of the leading edge has passed the clamp, the clamp is closed, thereby fixing a portion of the medium in the clamp. Upstream of the clamp, printing and transport may continue, since the web medium is buffered into the slack region. The blouse is formed while the clamp is closed, since web medium passes into the slack region, but not out of it, i.e. further transport to the take-up roller is prevented. The clamp prevents the wound roll from loosening or unwinding. This buffering provides the operator or a taping device with the time required to attach the leading edge region of the medium to the take-up roller. After attachment to a new roll core mounted on the take-up roller, winding of the web medium commences, and the clamp is be opened. When the clamp is opened the web medium is still in contact with the first surface which provides the friction force. Thereby, the web medium is tautly wound onto the roll core on the take-up roller.

In an even further embodiment, the printing system according to the present invention further comprises a further tensioning device provided in parallel to the tensioning device in a width direction of the transport path, wherein each of the tensioning devices comprises a friction level controller for controlling the friction force exerted by said tensioning device on a corresponding section of the web medium for adjusting the orientation of the web medium. Multiple tensioning devices in the width direction of the transport path may apply different friction forces to different portions of the web, as seen in the width direction. For example, a first or left tensioning device may provide a relatively large friction force, whilst a second or right tensioning device provides a relatively low friction force. This affects a counter-clockwise rotation of the medium, allowing the orientation of the medium on the transport path to be corrected. The friction force may in one example be easily controlled by controlling the urging force provided by each tensioning device. Each tensioning device may comprise an actuator for controlling the urging force, and thereby the friction force. This allows the tensioning device to correct the position and/or orientation of the web medium with respect to the transport path.

In another embodiment, wherein the tensioning device is controllable to switch between:
a web tensioning mode wherein the urging device exerts an urging force on the web medium; and
a web feeding mode, wherein the first surface is free of the urging force, such that the web medium is transported unimpeded over the first surface. In the web tensioning mode, the urging device acts on the web medium. For example, in case of an urging roller, the roller is in an urging position wherein the roller engages the web medium and presses it against the first surface. In case of a suction-based urging device, an under-pressure is applied to the first side of web medium to draw it against the first surface. In the web feeding mode, the urging device is configured not to exert a force on the web medium. In case of a roller, the roller is positioned in a feeding position remote from the first surface. In case of a suction-based urging device, the under-pressure is removed by e.g. turning off the suction device. The urging device when in operation forms an obstruction to a leading edge of a web medium being fed to the take-up roller. By switching the urging device to its web feeding mode, this obstruction is removed allowing the web medium to be swiftly and easily fed over the web medium.

In a further aspect, the present invention provides a tensioning device for use in a printing system according to the present invention, comprising:
a first surface for contacting a first side of a web medium;
a second surface for contacting a second side of the web medium; wherein the second surface is positionable with respect to the first surface to urge the web medium against the first surface, such that the first surface exerts a friction force on the web medium moving over the first surface in a direction opposite to a transport direction of a transport path of the printing system, thereby tensioning the web medium downstream of the tensioning device. The friction force results in a tensioning force on the web between the tensioning device and the take-up roller, thereby pulling, the web medium taut, resulting in a tightly wound media roll. Thereby, the object of the present invention has been achieved.

In a further aspect, the present invention provides a method for winding a web medium onto a take-up roller of a printing system, the method comprising the steps of:
transporting the web medium through a slack region wherein the web medium is slack;
winding the web medium onto the take-up roller downstream of the slack region;
while winding, a tensioning device exerting a friction force on the web medium downstream of the slack region and upstream of the take-up roller in a direction opposite to a transport direction of the medium, such that the web medium is tensioned between the tensioning device and the take-up roller. Due to the slack in the medium in the slack region, the web medium downstream of the slack region lacks sufficient tension for tightly winding the medium onto the take-up roller. The tensioning device provides a friction force working against the pulling force of the take-up roller. Thereby, the web is tensioned between the tensioning device and the take-up roller. This tensioning results in a tightly wound media roll. Thereby, the object of the present invention has been achieved.

In another embodiment, the step of transporting the web medium comprises the step of forming a blouse in the web medium in a buffer zone of the printing system upstream of the tensioning device. The blouse decouples the part of the web upstream of the blouse from the downstream part of the blouse, preventing the pulling forces from the take-up roller from shifting the section of the web medium currently being printed on. This improves the print quality.

In a further embodiment, the method according to the present invention further comprises the steps of:
a clamp clamping a section of the web medium upstream of the take-up roller and downstream of the slack region;
while clamping, attaching the web medium to the take-up roller;
releasing the clamped web medium, wherein the step of winding is performed after the web medium has been released by the clamp, such that the web medium may move freely through the clamp while winding.

Clamping the leading edge region, which has roughly a length corresponding to the distance between the clamp and the take-up roller, provides time for attaching the leading edge of the medium to the take-up roller. While the clamp is closed, the web medium is buffered into the slack region in the form of a U-shaped blouse. It will be appreciated that in an embodiment, the second surface of the tensioning device may be used for securely clamping the web medium as well as for pressing the moving medium onto the first surface to generate the friction force. In said embodiment the tensioning device forms the clamp.

In another embodiment, the step of exerting a friction force further comprises the step of urging the web medium against a first surface of the tensioning device for providing the friction force. Urging may comprise pushing the web medium onto the first surface and allows for controlling the friction force. This allows a wide variety of different media to be applied in the method according to the present invention.

In a further embodiment, the step of urging further comprises pushing a roller against the web medium to urge the web medium against the first surface. In a preferred embodiment, the urging element is a roller. The outer surface of the roller provides little to none additional friction to the web medium, as it moves in correspondence with the web medium. This allows for accurate control of the friction force, as the friction force is determined by the urging force. In another example, the web medium is urged against the first surface by a vacuum or suction force, which is provided to the medium via vacuum holes in the first surface.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A is a perspective view of an embodiment of a printing system according to the present invention;

FIG. 1B is a perspective view of a printing assembly of the printing system in FIG. 1A;

FIG. 2A is a schematic side view of a printing system according to the prior art before attachment of the leading to the take-up roller;

FIG. 2B is a schematic side view of the printing system in FIG. 2A while printing;

FIG. 3 is a schematic side view of a section of a printing system according to the present invention downstream of the printing assembly;

FIG. 4A is a schematic side view of a tensioning device according to the present invention with the clamp open;

FIG. 4B is a schematic side view of a tensioning device according to the present invention with the clamp closed;

FIG. 5 is a schematic side view of a further embodiment of a printing system according to the present invention;

FIG. 6 is a schematic side view of an even further embodiment of a printing system according to the present invention;

FIG. 7 is a schematic top view of another embodiment of a tensioning device according to the present invention; and

FIG. 8 is a schematic side view of another embodiment of a printing system according to the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

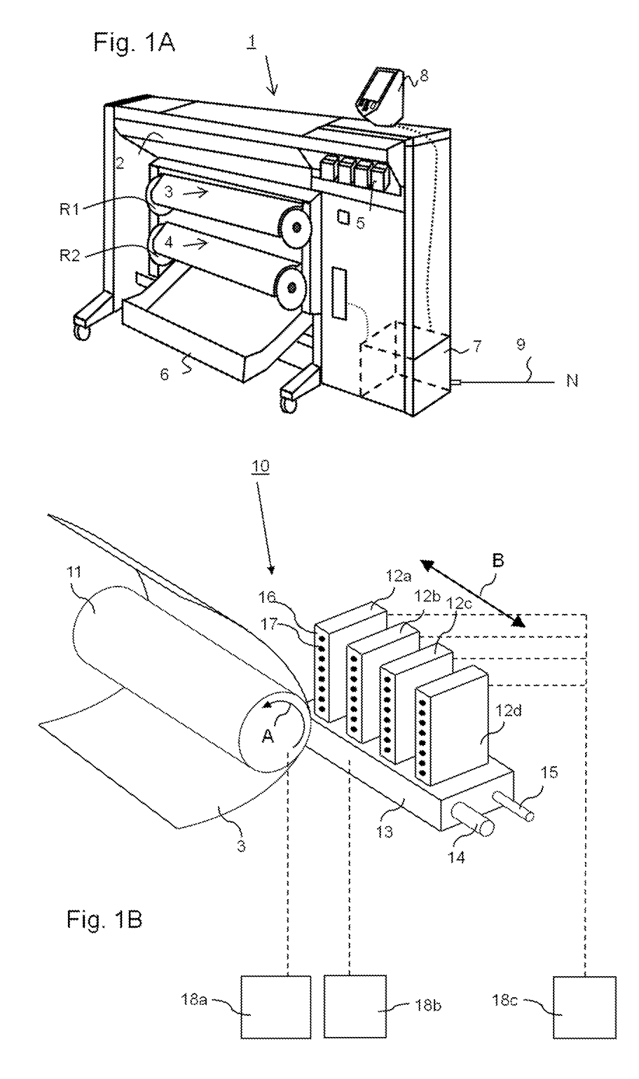

FIG. 1A shows an image forming apparatus 1, wherein printing is achieved using a wide format inkjet printer. The wide-format image forming apparatus 1 comprises a housing 2, wherein the printing assembly, for example the ink jet printing assembly shown in FIG. 1B is placed. The image forming apparatus 1 also comprises a storage means for storing image receiving member 3, 4, a delivery station to collect the image receiving member 3, 4 after printing and storage means 5 for marking material. In FIG. 1A, the delivery station is embodied as a delivery tray 6. Optionally, the delivery station may comprise processing means for processing the image receiving member 3, 4 after printing, e.g. a folder or a puncher. The wide-format image forming apparatus 1 furthermore comprises means for receiving print jobs and optionally means for manipulating print jobs. These means may include a user interface unit 8 and/or a control unit 7, for example a computer.

Images are printed on an image receiving member, for example paper, supplied by a roll 3, 4. The roll 3 is supported on the roll support R1, while the roll 4 is supported on the roll support R2. Alternatively, cut sheet image receiving members may be used instead of rolls 3, 4 of image receiving member. Printed sheets of the image receiving member, cut off from the roll 3, 4, are deposited in the delivery tray 6.

Each one of the marking materials for use in the printing assembly are stored in four containers 5 arranged in fluid connection with the respective print heads for supplying marking material to said print heads.

The local user interface unit 8 is integrated to the print engine and may comprise a display unit and a control panel. Alternatively, the control panel may be integrated in the display unit, for example in the form of a touch-screen control panel. The local user interface unit 8 is connected to a control unit 7 placed inside the printing apparatus 1. The control unit 7, for example a computer, comprises a processor adapted to issue commands to the print engine, for example for controlling the print process. The image forming apparatus 1 may optionally be connected to a network N. The connection to the network N is diagrammatically shown in the form of a cable 9, but nevertheless, the connection could be wireless. The image forming apparatus 1 may receive printing jobs via the network. Further, optionally, the controller of the printer may be provided with a USB port, so printing jobs may be sent to the printer via this USB port.

FIG. 1B shows an ink jet printing assembly 10. The ink jet printing assembly 10 comprises supporting means for supporting an image receiving member 3. The supporting means 11 are shown in FIG. 1B as a platen 11, but alternatively, the supporting means 11 may be a flat surface. The platen 11, as depicted in FIG. 1B, is a rotatable drum 11, which is rotatable about its axis as indicated by arrow A. The supporting means 11 may be optionally provided with suction holes for holding the image receiving member 3 in a fixed position with respect to the supporting means 11. The ink jet printing assembly 10 comprises print heads 12a-12d, mounted on a scanning print carriage 13. The scanning print carriage 13 is guided by suitable guiding means 14, 15 to move in reciprocation in the main scanning direction B. Each print head 12a-12d comprises an orifice surface 16, which orifice surface 16 is provided with at least one orifice 17. The print heads 12a-12d are configured to eject droplets of marking material onto the image receiving member 3. The platen 11, the carriage 13 and the print heads 12a-12d are controlled by suitable controlling means 18a, 18b and 18c, respectively.

The image receiving member 3 may be a medium in web or in sheet form and may be composed of e.g. paper, cardboard, label stock, coated paper, plastic or textile. Alternatively, the image receiving member 3 may also be an intermediate member, endless or not. Examples of endless members, which may be moved cyclically, are a belt or a drum. The image receiving member 3 is moved in the sub-scanning direction A by the platen 11 along four print heads 12a-12d provided with a fluid marking material.

A scanning print carriage 13 carries the four print heads 12a-12d and may be moved in reciprocation in the main scanning direction B parallel to the platen 11, such as to enable scanning of the image receiving member 3 in the main scanning direction B. Only four print heads 12a-12d are depicted for demonstrating the invention. In practice an arbitrary number of print heads may be employed. In any case, at least one print head 12a-12d per color of marking material is placed on the scanning print carriage 13. For example, for a black-and-white printer, at least one print head 12a-12d, usually containing black marking material is present. Alternatively, a black-and-white printer may comprise a white marking material, which is to be applied on a black image-receiving member 3. For a full-color printer, containing multiple colors, at least one print head 12a-12d for each of the colors, usually black, cyan, magenta and yellow is present. Often, in a full-color printer, black marking material is used more frequently in comparison to differently colored marking material. Therefore, more print heads 12a-12d containing black marking material may be provided on the scanning print carriage 13 compared to print heads 12a-12d containing marking material in any of the other colors. Alternatively, the print head 12a-12d containing black marking material may be larger than any of the print heads 12a-12d, containing a differently colored marking material.

The carriage 13 is guided by guiding means 14, 15. These guiding means 14, 15 may be rods as depicted in FIG. 1B. The rods may be driven by suitable driving means (not shown). Alternatively, the carriage 13 may be guided by other guiding means, such as an arm being able to move the carriage 13. Another alternative is to move the image receiving material 3 in the main scanning direction B.

Each print head 12a-12d comprises an orifice surface 16 having at least one orifice 17, in fluid communication with a pressure chamber containing fluid marking material provided in the print head 12a-12d. On the orifice surface 16, a number of orifices 17 is arranged in a single linear array parallel to the sub-scanning direction A. Eight orifices 17 per print head 12a-12d are depicted in FIG. 1B, however obviously in a practical embodiment several hundreds of orifices 17 may be provided per print head 12a-12d, optionally arranged in multiple arrays. As depicted in FIG. 1B, the respective print heads 12a-12d are placed parallel to each other such that corresponding orifices 17 of the respective print heads 12a-12d are positioned in-line in the main scanning direction B. This means that a line of image dots in the main scanning direction B may be formed by selectively activating up to four orifices 17, each of them being part of a different print head 12a-12d. This parallel positioning of the print heads 12a-12d with corresponding in-line placement of the orifices 17 is advantageous to increase productivity and/or improve print quality. Alternatively multiple print heads 12a-12d may be placed on the print carriage adjacent to each other such that the orifices 17 of the respective print heads 12a-12d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 17.

Upon ejection of the marking material, some marking material may be spilled and stay on the orifice surface 16 of the print head 12a-12d. The ink present on the orifice surface 16, may negatively influence the ejection of droplets and the placement of these droplets on the image receiving member 3. Therefore, it may be advantageous to remove excess of ink from the orifice surface 16. The excess of ink may be removed for example by wiping with a wiper and/or by application of a suitable anti-wetting property of the surface, e.g. provided by a coating.

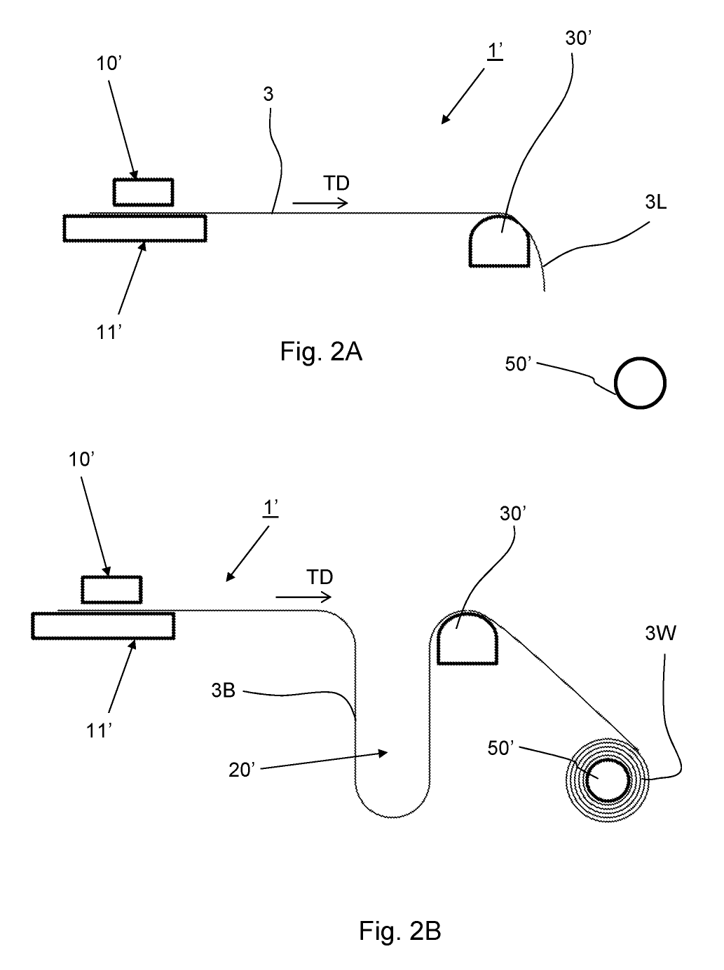

FIG. 2A shows a printing system 1′ according to the prior art. A web medium 3 is provided along the transport path to the printing assembly 10′, where it may be supported on the print surface 11′ while printing. Prior to printing the leading edge 3 L of the medium 3 is transported to the take-up roller 50′ for attachment thereto. While taping the leading edge region 3 L may rest on a support element 30′. After attachment, printing commences, as shown in FIG. 2B. The take-up roller 50′ winds up the medium 3 output by the printing assembly 10′. Between the printing assembly 10′ and the take-up roller 50′ a buffer region or zone 30′ is provided. Therein, the medium 3 hangs unsupported in a U-shape 3B to decouple the pulling forces from the take-up roller 50′ from the section of the web medium on the print surface 11′. The buffer zone 20 may be defined by an upstream support element, which defines the upstream end of the buffer zone 20, and a downstream support element, which defines the downstream end of the buffer zone 20. The upstream support element may in an example be a downstream end of the print surface 11′ or be formed by a separate support element. After the upstream support element, the web medium is curves downwards under the influence of gravity into a lower lying region of the print system. Preferably a pushing transport mechanism, such as a transport pinch, is provided upstream of the buffer zone 20′ to push the web medium 3 into the buffer zone 20. After reaching its lowest point, the web medium 3 is directed up towards the downstream support element 30′. Basically, the web medium 3 hangs between the upstream and downstream support elements, at least during the initial phase of buffering. It will be appreciated that the blouse 3B need not be always U-shaped. When longer buffer times are required the web medium 3 may come into contact with a bottom support surface, which results in the formation of additional folds in the web medium 3 in the buffer zone 20′.

Drawback of the configuration in FIG. 2B is that the web medium 3 becomes loosely wound on the take-up roller 50′. Air is trapped between layers of web medium 3 wound onto the roller 50′ increasing the overall volume of the media roll 3W. Additional storage space is then required when transporting or storing such loosely wound rolls 3W. A further drawback is that the loosely wound media roll 3W is unstable and difficult to handle. When horizontal, the media roll 3W is balanced, but, when tilted, the different layers of the wound web medium 3W slide over one another under the influence of gravity. This may result in damage to the medium 3 and makes transporting the media roll 3W cumbersome. Operators are required to seal the media roll 3W in a container or packaging or to provide additional flanges to prevent the lateral sliding of the web medium 3.

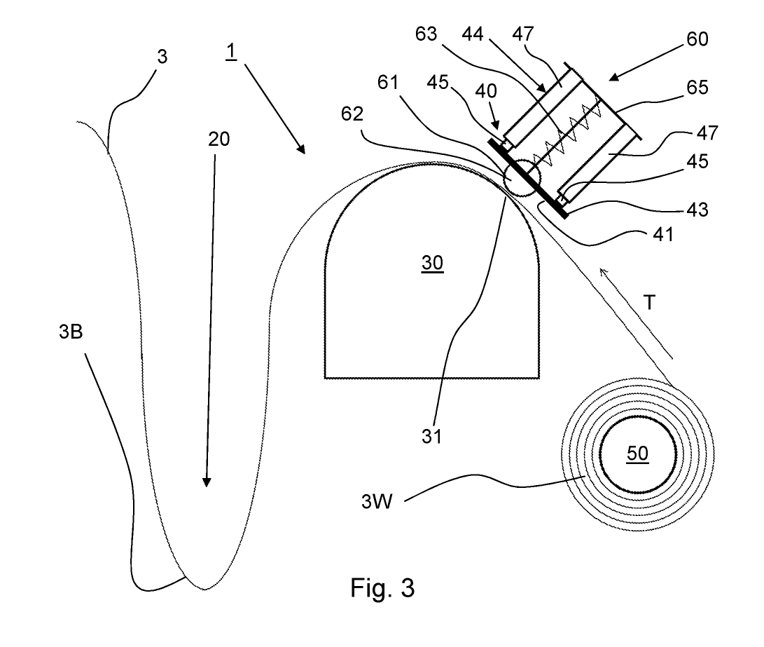

FIG. 3 shows a schematic side view of a section of a printing system 1 according to the present invention. Downstream of the printing assembly 10, the transport path comprises a buffer zone 20, wherein the web medium 3 may be hung as a blouse 3B, as described for FIG. 2A. The web medium 3 is pushed into the buffer zone 20 by a transport pinch upstream of the printing assembly and pulled out of said buffer zone by a take-up roller 50 via a downstream support element 30. The top side of the support element 30 forms a first surface 31 for supporting the web medium 3. Opposite to the first surface 31 with respect to the medium 3, a tensioning device 60 is provided. The tensioning 60 device comprises a second surface 61 provided on the roller 62. The second surface 61 of the roller 62 is urged onto the web medium 3 towards the first surface 31 by the urging element 63, formed as a pre-tensioned spring 63. Thereby, the first surface 31 exerts a friction force on the web medium 3 opposite to the transport direction TD of the web medium 3. This friction force works against the pulling force of the take-up roller 50 resulting in a tensioning force T. In consequence, the web medium 3 downstream of the tensioning device 60 is pulled taut, resulting in tightly wound media rolls 3W.

Additionally, the tensioning device 60 comprises a clamp 40 with an actuator 44 for pressing a stop surface 41 onto the web medium 3 on the first surface 31. Thereby, a section of the web medium 3 may be held in place, allowing the web medium 3 to form a blouse in the buffer zone 20, while a leading edge region 3L is attached to the take-up roller 50. The stop surface 41 is provided on a stop plate 43, which is connected to a fixed frame 65 of the printing system 1 via the actuators 44. The first surface 31 and the stop surface 41 are pressed together by the actuator 44 to clamp and hold the web medium 3 between them. In FIG. 3, two parallel actuators 44 are provided, though it is within the scope of the present invention to apply a single actuator 44. The actuator 44 may be controlled via a controller (not shown) to clamp the web 3 in correspondence with an arrival of a leading or cutting edge in the area between the clamp 40 and the take-up roller 50. Alternatively, the clamp 40 may be operated manually by the operator. The stop surface 41 may be provided with a resilient layer to prevent damage to the printed medium 3.

The support element 30 is preferably a static support element 30, which may be provided with flanges for positioning the web medium 3 with respect to the transport path or take-up roller 50. Said flanges are described in European Patent Application EP15189787.3, specifically in FIGS. 2 and 3 and the corresponding sections of the detailed description of said Figures. The support element 30 or guide element 30 comprises a curved first surface 31 which supports the web medium 3 and locally defines the transport path. From the first surface 31 the web medium 3 extends to the take-up roller 50. The friction-based tensioning device 60 ensures that the web medium 3 extends in a substantially straight line from the first surface 31 to the take-up roller 50 by locally tensioning the web medium 3 between these two components 31, 50.

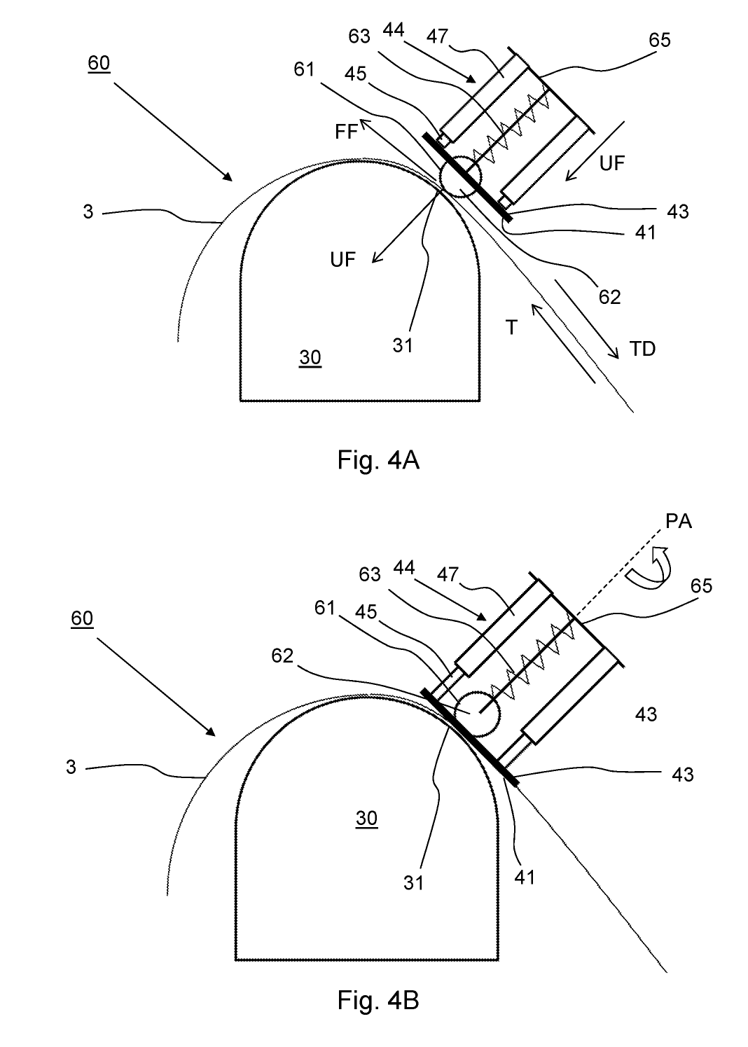

FIG. 4A shows a close-up view of the tensioning device 60. In FIG. 4A, the clamp 40 is in the open position allowing the web medium 3 to move over the first surface 31 to the take-up roller 50. Thereto, the actuators 44 have moved the stop plate 43 with the stop surface 41 away from the first surface 31 to form a gap through which the web medium 3 is able to pass. The roller 62 is connected to the fixed frame 65 of the printing system 1 by means of the urging element 63. This spring 63 provides a continuous force UF on the roller 62, such that the second surface 61 on the roller 63 is pressed against the web medium 3 on the first surface 31. Thereby, the web medium 3 is moveably held between the first and second surfaces, 31, 61. The pressing of the roller 62 on the first surface 31 results in a continuous friction force FF directed opposite to the transport direction TD of the web medium 3 on the first surface 31. Since the friction force FF acts opposite to the pulling force provided by the take-up roller 50, the web medium 3 between the tensioning device 60 and the take-up roller 50 is tensioned, shown as tensioning force T. In consequence, the web medium 3 in this region is pulled taut and the web medium 3 is wound onto the take-up roller 50 under constant tension, ensuring a tightly wound media roll 3W. The friction force FF is preferably small and may be controlled by setting or adjusting the urging force UF. Thereto different spring constants may be applied for different media or in another embodiment an urging actuator may be used to apply a predefined urging force UF onto the web medium 3. This allows the operator or controller to set a desired friction force FF, such that the web medium 3 may continually slip over the first surface 31 without the risk of tearing the medium 3.

The urging force UF is directed perpendicular to the plane of the first surface 31, such that the urging force UF does directly not urge the top surface of the web medium 3 in a direction parallel to the first surface 31. This prevents deformation of the web medium 3 and damage to the printed image.

FIG. 4B illustrates the tensioning device 60 with the clamp 40 in its closed state. Therein, the web medium 3 is clamped and secured between the first and second surfaces 31, 61, such that the web medium 3 cannot move further than the first surface 31 in the transport direction TD. By closing the clamp 40 a blouse 3B may be formed in the buffer zone 20. The size of the blouse 3B may be controlled by controlling the period in which the clamp 40 closed. Additionally, the clamp 40 may be closed immediately upstream of a trailing edge to hold the web medium 3 on the roll 3W under tension to await taping of the roll 3W by an operator.

Preferably, the roller 61 is free to rotate along its rotation axis, thereby imparting substantial no or little forces on the web medium 3 directed in the transport direction TD. This allows for an accurate control of the friction force FF, which may be easily determined by selecting the appropriate urging force UF, for example based on the media type and/or atmospheric conditions. In an embodiment, the roller 61 may be arranged to pivot around pivoting axis PA to prevent the roller 61 from exerting lateral forces on the web 3. This prevents the roller 61 from changing the lateral position of the web 3. The axis PA is preferably perpendicular to the transport direction TD and oriented out-of-plane with respect to the medium 3 on the first surface 31.

New web media 3 may be easily fed to the take-up roller 50 by positioning the roller 61 remote from the first surface 31. Thereby a suitable passage for feeding the new web media 3 is formed. No additional modification of the printing system 1 is required, as the first surface 31 still forms a suitable transport path. This is particularly advantageous for printing jobs requiring different media types. A controller 7 may control the urging device 61 to move to its remote web feeding position, when an automated web feeding mechanism is controlled to push the media 3 from the input roller R1, R2 to the take-up roller 50.

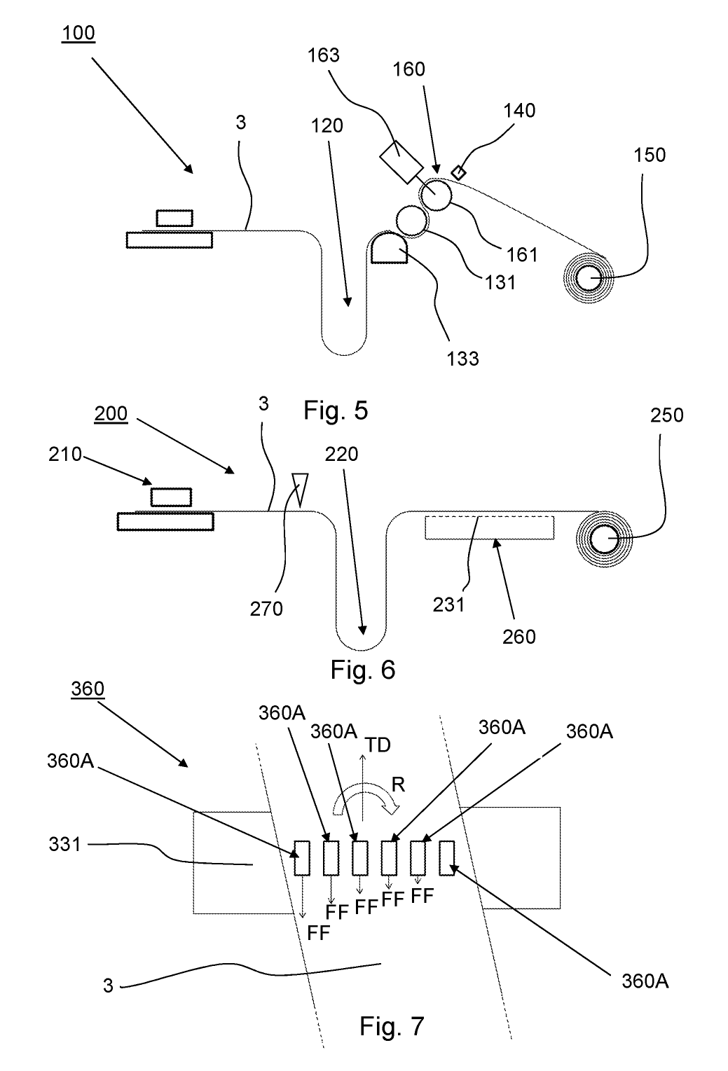

FIG. 5 illustrates a further embodiment of a printing system 100 according to the present invention. The tensioning device 160 in FIG. 5 is configured differently than the tensioning device 60 in FIGS. 3 and 4A, B. In FIG. 5, the friction force FF is provided by passing the web medium 3 through an S-shaped curve formed by a pair of curved guide surfaces 131, 161. In Fig. the guide surface 131 and 161 are formed by bars 131, 161, which each comprise a curved surface for forming the S-shaped section of the transport path. The actuator 163 may position the second guide bar 161 in a desired position and/or pull on said guide bar 161 to generate to the desired friction force. The embodiments of FIGS. 3 and 4A, B provide a simpler transport path than FIG. 5, such that the feeding of the leading edge of the web medium may be performed more easily and quicker in FIGS. 3 and 4A, B. The page-wide bars 131, 161 in FIG. 5 are well-suited for very flexible print media, such as foils. Preferably, the guide surface 161 is substantially smooth surfaces to provide little friction.

FIG. 6 illustrates an even further embodiment of a printing system 200 according to the present invention. The tensioning device 260 in FIG. 6 is configured differently than the tensioning device 60 in FIGS. 3 and 4A, B. The tensioning device 260 comprises a support surface 231 provided with through-holes. Via the through-holes air may be sucked into the tensioning device 260 by means of a vacuum source connected thereto. Via the through-holes a suction force may be applied to the web medium 3 on the support surface 231. The suction force determines the friction force FF, which may then be easily controlled by adjusting the air flow through the tensioning device 260. This allows for a highly accurate control of the friction force FF.

In FIG. 6 a cutter 270 is positioned along the transport path for cutting the medium 3 between the printing assembly 210 and the buffer zone 220 for forming the blouse 3B. Prior to cutting the blouse in the buffer region 220 is “eaten up” to remove or substantially reduce the size of the blouse from the medium 3 in the buffer zone 220. The medium 3 is then cut by the cutter 270. By “eating up” the blouse, it is prevented that, after cutting, a region of medium 3 in the buffer zone 220 may fall onto the ground and become contaminated. The tensioning device 231 maintains a constant tension on the wound medium 3W, so winding may continue without being interrupted by said cutting. Additionally, the tensioning device 3 prevents a trailing portion of a cut medium 3 from sliding over the first surface 231 and falling onto the ground between the first surface 231 and the take-up roller 250.

FIG. 7 illustrates another embodiment of a printing system 300 according to the present invention. The tensioning device array 360 in FIG. 7 comprises a plurality of tensioning devices 360A spaced apart from one another in the width direction of the web medium 3 on the transport path. A controller is arranged for selecting the friction force FF exerted by each tensioning device 360A independently of that of the other tensioning devices 360A. This is illustrated by the different lengths of the friction forces FF of each of the tensioning devices 360A. By applying different friction forces over the width of the medium 3, the medium 3 may be rotated to correct skewing of the medium 3. It can be seen in FIG. 7 that the medium 3 is skewed, i.e. at an angle with respect to the transport path or the transport direction TD. In order to properly align the medium 3 on the first surface 331, the tensioning devices 360A apply a friction force profile oriented correspondingly to the skewing of the medium 3, such that the medium 3 is rotated back into alignment with transport path. The rotation R of the medium 3 may be controlled by activating one or more tensioning devices 360A. A clockwise rotation R is achieved by selecting one or more tensioning device 360A on the right side of the medium 3, as seen in the transport direction TD. Applying a larger friction force on the left side of the medium 3 than on its right side, rotates the medium 3 counter-clockwise.

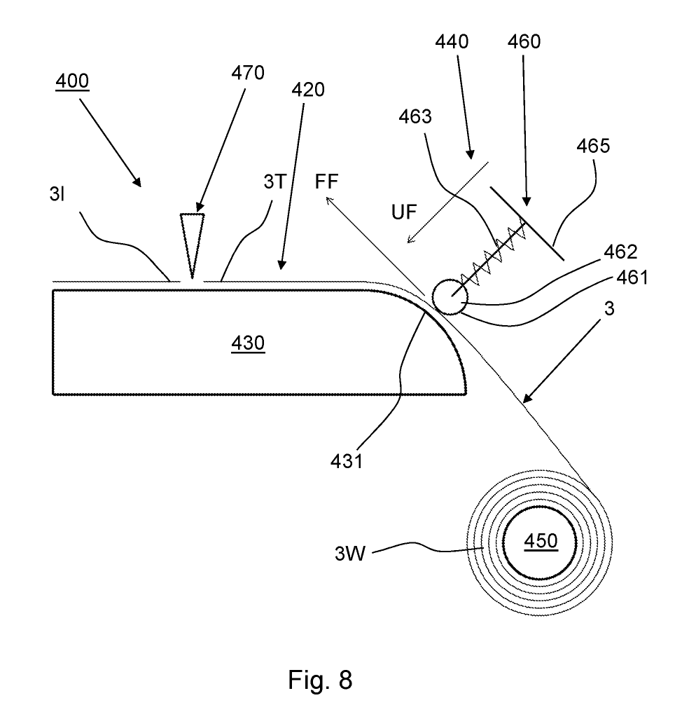

FIG. 8 illustrates an additional embodiment of a printing system 400 according to the present invention. A cutter 470 is provided upstream of the tensioning device 460 and downstream of the printing assembly (not shown). The cutter 470 is arranged for cutting the medium 3 along its width direction, thereby forming an upstream medium 3 with a trailing edge 3T upstream of a leading edge 3L of a downstream medium 3. In FIG. 8, the second surface 461 is used for pressing the medium 3 onto the first surface 431 as well as for clamping and immobilizing the medium 3 between the first and second surfaces 431, 461. This may be done by controlling the urging force UF, for example by applying a relatively low urging force UF for providing the friction force FF and allowing the medium 3 to move over the first surface 431 and by applying a relatively large urging force UF when the medium 3 needs to be securely clamped between the first and second surfaces 431, 461. Alternatively, a lock or brake may be provided for preventing a rotation of the roller 462 around its rotation axis. Thereby, the number of components may be reduced, as the clamping and friction force FF may both be provided by the roller 461.

The medium 3 is preferably cut under tension by the cutter 470. In the slack region (or tension-free region) between the cutter 470 and the tensioning device 460 the medium 3 is substantially tensionless or tension-free, especially when compared to a high tension section of the medium upstream of the printing assembly. The tension in the medium 3 increases downstream of the roller 462. The roller 462 tensions the section of the web 3 between the roller 462 and the take-up roller 450. This allows a cut web 3 to be wound under tension. The roller 462 further provides a holding force on the web 3 on the first surface 431, which prevents the web 3 from sliding over the first surface 431 under the effect of gravity and falling onto the ground between the roller 462 and the take-up roller 450. An additional advantage of the friction-based tensioning device is that it prevents the web medium 3 from sliding over the first surface 431 and forming a blouse in the region between the tensioning device 461 and the take-up roller 450. Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A printing system for web media, comprising:
a transport path for transporting a web medium through the printing system, the transport path comprising a slack region wherein the web medium is slack;
a take-up roller positioned at a downstream end of the transport path for receiving and winding the web medium; and
a tensioning device positioned along the transport path between the slack region and the take-up roller, wherein the tensioning device comprises:
a stationary first surface; and
an urging device for urging the web medium against the first surface, such that the first surface exerts a friction force on the web medium moving over the first surface in a direction opposite to a transport direction of the transport path, thereby tensioning the web medium between the tensioning device and the take-up roller.

2. The printing system according to claim 1, wherein the urging device is configured, such that an urging force exerted by the urging device on the web medium is substantially perpendicular to the web medium on the first surface.

3. The printing system according to claim 1, wherein the urging device is configured, such that:
the friction force acts on a first side of the web medium facing the first surface; and
an urging force exerted by the urging device on a second side of the web medium does not substantially impede movement of the web medium in the transport direction.

4. The printing system according to claim 1, further comprising a stationary page-wide support element for supporting a bottom side of the web medium, said stationary support element comprising the stationary first surface.

5. The printing system according to claim 1, wherein:
the first surface of the tensioning device is arranged for contacting a first side of the web medium;
the tensioning device further comprises a second surface for contacting a second side of the web medium; and
the second surface is positioned with respect to the first surface to urge the web medium against the first surface, such that the first surface exerts the friction force on the web medium.

6. The printing system according to claim 5, wherein the urging device is arranged for urging the second surface towards the first surface.

7. The printing system according to claim 1, wherein the tensioning device further comprises a plurality of laterally spaced apart rollers and a support plate forming the first surface, wherein the urging device comprises a plurality of urging elements for urging each roller towards the support plate.

8. The printing system according to claim 7, wherein each roller is rotatable around a rotation axis substantially parallel to a plane of the web medium on the transport path, and wherein each roller is further pivotable around a pivoting axis perpendicular to the plane of the web medium on the transport path, such that each roller may pivot over the web medium on the transport path.

9. The printing system according to claim 1, wherein the tensioning device is controllable to switch between:
a web tensioning mode wherein the urging device exerts an urging force on the web medium; and
a web feeding mode, wherein the first surface is free of the urging force, such that the web medium is transported unimpeded over the first surface.

10. The printing system according to claim 1, comprising a further tensioning device provided in parallel to the tensioning device in a width direction of the transport path, wherein each of the tensioning devices comprises a friction level controller for controlling the friction force exerted by said tensioning device on a corresponding section of the web medium for adjusting the orientation of the web medium.

11. A method for winding a web medium onto a take-up roller of the printing system according to claim 1, the method comprising the steps of:
transporting the web medium through a slack region wherein the web medium is slack;
winding the web medium onto the take-up roller downstream of the slack region;
transporting the web medium over a stationary first surface positioned between the slack region and the take-up roller; and
while winding, urging the web medium with the tensioning device against the stationary first surface, such that the stationary first surface exerts a friction force on the web medium in a direction opposite to a transport direction of the web medium, thereby tensioning the web medium between the tensioning device and the take-up roller.

12. The method according to claim 11, wherein the step of transporting the web medium further comprises the step of forming a blouse in the web medium in a buffer zone of the printing system upstream of the tensioning device.

13. The method according to claim 11, further comprising the steps of:
a clamp clamping a section of the web medium upstream of the take-up roller and downstream of the slack region;
while clamping, attaching the web medium to the take-up roller; and
releasing the clamped web medium,
wherein the step of winding is performed after the web medium has been released by the clamp, such that the web medium may move freely through the clamp while winding.

14. Method The method according to claim 11, wherein the step of exerting a friction force further comprises the step of urging the web medium against a first surface of the tensioning device for providing the friction force.

15. The method according to claim 14, wherein the step of urging further comprises the step of pushing a roller against the web medium to urge the web medium against the first surface.
